(19) United States
(12) Patent Application Publication
(10) Pub. No.: US 2013/0308424 A1
(43) Pub. Date: Nov. 21, 2013

(54) Method of Generating and Characterizing a Seismic Signal in a Drill Bit

(71) Applicant: Sunil Kumar, Celle (DE)

(72) Inventor: Sunil Kumar, Celle (DE)

(73) Assignee: BAKER HUGHES INCORPORATED, HOUSTON, TX (US)

(21) Appl. No.: 13/475,314

(22) Filed: May 18, 2012

(51) Int. Cl. E21B 47/14; G01V 1/40; E21B 47/16

(52) U.S. Cl. 367/82; 367/81

(57) ABSTRACT

A method, apparatus and system for estimating a parameter of interest downhole is disclosed. An acoustic source signal is generated at a drill bit downhole. The generated acoustic source signal is received at a source sensor at the drill bit. A character of the generated acoustic source signal is determined from the received signal at the source sensor. The characterized source signal is used to estimate the downhole parameter of interest.

### BACKGROUND OF THE DISCLOSURE

1. Field of the Disclosure

The present disclosure is related to seismic testing in petroleum exploration and, more specifically, to characterizing an acoustic source signal used in seismic testing.

2. Description of the Related Art

In petroleum exploration, various acoustic and seismic tests may be performed to determine a formation property. Some of these tests use a drill bit to produce an acoustic or seismic signal, referred to herein as a source signal. This source signal propagates through a medium, such as the formation, and is received at one or more sensors that are generally at a location separate from the drill bit. The medium affects various aspects of the signal propagating through it, such as amplitude, frequency, etc., as a result of the medium's various properties and/or of features located in the medium. Thus, the received signal may be compared to the source signal and the differences in the signal may be used to determine these various properties and/or features of the medium. However, due to various factors, such as drill bit noise, formation interference, etc., the character of the source signal, such as its signal waveform or frequency spectrum, is often not fully known. Therefore, comparison between the received signal and the source signal includes errors that limit how well the various properties, features, etc. of the medium can be determined. Thus, there is a need to characterize the source signal at its source, i.e., at the drill bit.

### SUMMARY OF THE DISCLOSURE

In one aspect the present disclosure provides a method estimating a parameter of interest downhole, the method including: generating an acoustic source signal at a drill bit downhole; receiving the acoustic signal at a sensor at the drill bit; determining a character of the generated acoustic signal from the received signal at the sensor at the drill bit; and estimating the downhole parameter of interest using the characterized signal.

In another aspect, the present disclosure provides an apparatus for estimating a parameter of interest downhole, including: an acoustic source at a drill bit located downhole configured to generated an acoustic signal; a sensor at the drill bit configured to receive the acoustic signal; and a processor configured to: determine a character of the generated acoustic signal from the signal received at the sensor at the drill bit, and estimate the downhole parameter of interest using the characterized signal.

In yet another aspect, the present disclosure provides a downhole acoustic testing system that includes a drillstring disposed in a wellbore; an acoustic source located at a downhole end of the drill string configured to generated an acoustic signal; a sensor at the drill bit configured to receive the generated acoustic signal at the drill bit; and a processor configured to: determine a character of the generated acoustic signal from the signal received at the sensor at the drill bit, and estimate a downhole parameter of interest using the characterized signal.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows a schematic diagram of a drilling system for drilling a wellbore in an earth formation and for estimating properties or characteristics of interest of the formation surrounding the wellbore during the drilling of the wellbore;

FIG. 2 shows an exemplary earth-boring drill bit for generating an acoustic signal in an exemplary embodiment of the present disclosure;

FIG. 3 shows the exemplary bit of FIG. 2 disposed at an exemplary bottomhole assembly at an end of an exemplary drill string in one embodiment of the present disclosure;

FIG. 4 shows the exemplary drill bit of FIG. 2 at an end of a drill string that may be used, for example, to perform vertical profiling of a formation; and

FIG. 5 shows a drill bit having a set of remote sensors usable to measure a formation parameter in an alternate embodiment of the present disclosure.

### DETAILED DESCRIPTION OF THE DISCLOSURE

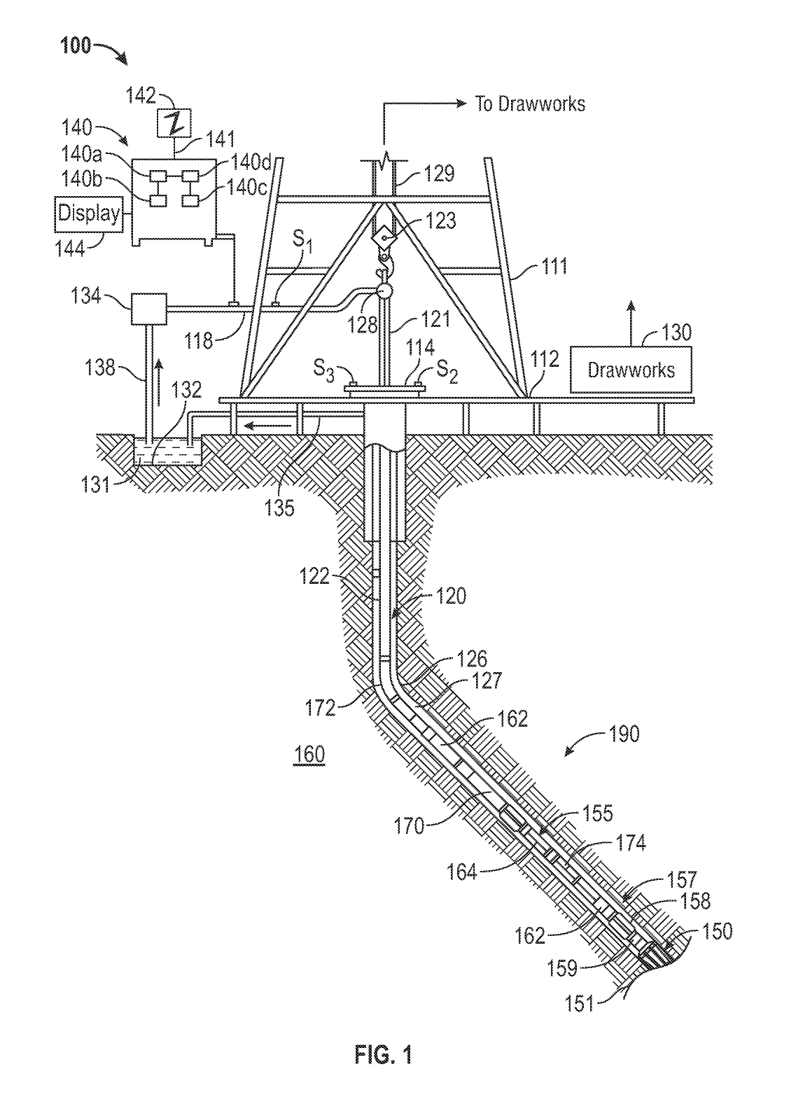

FIG. 1 shows a schematic diagram of a drilling system 100 for drilling a wellbore 126 in an earth formation 160 and for estimating properties or characteristics of interest of the formation surrounding the wellbore 126 during the drilling of the wellbore 126. The drilling system 100 is shown to include a drill string 120 that comprises a drilling assembly or bottomhole assembly (BHA) 190 attached to a bottom end of a drilling tubular (drill pipe) 122. The drilling system 100 is further shown to include a conventional derrick 111 erected on a floor 112 that supports a rotary table 114 that is rotated by a prime mover, such as an electric motor (not shown), to rotate the drilling tubular 122 at a desired rotational speed. The drilling tubular 122 is typically made up of jointed metallic pipe sections and extends downward from the rotary table 114 into the wellbore 126. A drill bit 150 attached to the end of the BHA 190 disintegrates the geological formations when it is rotated to drill the wellbore 126. The drill string 120 is coupled to a drawworks 130 via a Kelly joint 121, swivel 128 and line 129 through a pulley 123. During the drilling of the wellbore 126 draw works 130 controls the weight on bit (WOB) which affects the rate of penetration.

During the drilling operations, a suitable drilling fluid or mud 131 from a source or mud pit 132 is circulated under pressure through the drill string 120 by a mud pump 134. The drilling fluid 131 passes from the mud pump 134 into the drilling tubular 122 via a desurger (not shown) and a fluid line 118. The drilling fluid 131 is discharged at the wellbore bottom 151 through an opening in the drill bit 150. The drilling fluid 131 circulates uphole through an annular space 127 between the drill string 120 and the wellbore 126 and returns to the mud pit 132 via return line 135. A sensor S₁ in the line 138 provides information about the fluid flow rate. A surface torque sensor S₂ and a sensor S₃ associated with the drill string 120 respectively provide information about the torque and the rotational speed of the drill string. Additionally, one or more sensors (collectively referred to as S₄) associated with line 129 are typically used to provide information about the hook load of the drill string 120 and other desired drilling parameters relating to drilling of the wellbore 126.

In some applications the drill bit 150 is rotated by rotating only the drilling tubular 122. However, in other applications a drilling motor (also referred to as the “mud motor”) 155 disposed in the drilling assembly 190 is used to rotate the drill bit 150 and/or to superimpose or supplement the rotational speed of the drilling tubular 122.

The system 100 may further include a surface control unit 140 configured to provide information relating to the drilling operations and for controlling certain desired drilling operations. In one aspect, the surface control unit 140 may be a computer-based system that includes one or more processors (such as microprocessors) 140a, one or more data storage devices (such as solid state-memory, hard drives, tape drives, etc.) 140b, display units and other interface circuitry 140c. Computer programs and models 140d for use by the processors 140a in the control unit 140 are stored in a suitable data storage device 140b, including, but not limited to: a solid-state memory, hard disc and tape. The surface control unit 140 may communicate data to a display 144 for viewing by an operator or user. The surface control unit 140 also may interact with one or more remote control units 142 via any suitable data communication link 141, such as the Ethernet and the Internet. In one aspect, signals from downhole sensors 162 and downhole devices 164 (described later) are received by the surface control unit 140 via a communication link, such as fluid, electrical conductors, fiber optic links, wireless links, etc. The surface control unit 140 processes the received data and signals according to programs and models 140d provided to the surface control unit and provides information about drilling parameters such as weight-on-bit (WOB), rotations per minute (RPM), fluid flow rate, hook load, etc. and formation parameters such as resistivity, acoustic properties, porosity, permeability, etc. The surface control unit 140 records such information. This information, either alone or along with information from other sources, may be utilized by the control unit 140 and/or a drilling operator at the surface to control one or more aspects of the drilling system 100, including drilling the wellbore along a desired profile (also referred to as “geosteering”).

Still referring to FIG. 1, BHA 190, in one aspect, may include a force application device 157 that may contain a plurality of independently-controlled force application members 158, each of which may be configured to apply a desired amount of force on the wellbore wall to alter the drilling direction and/or to maintain the drilling of the wellbore 126 along a desired direction. A sensor 159 associated with each respective force application member 158 provides signals relating to the force applied by its associated member. The drilling assembly 190 also may include a variety of sensors, collectively designated herein by numeral 162, located at selected locations in the drilling assembly 190, that provide information about the various drilling assembly operating parameters, including, but not limited to: bending moment, stress, vibration, stick-slip, tilt, inclination and azimuth. Accelerometers, magnetometers and gyroscopic devices, collectively designated by numeral 174, may be utilized for determining inclination, azimuth and tool face position of the drilling assembly operating parameters, using programs and models provided to a downhole control unit 170. In another aspect, the sensor signals may be partially processed downhole by a downhole processor at the downhole control unit 170 and then sent to the surface controller 140 for further processing.

Still referring to FIG. 1, the drilling assembly 190 may further include any desired MWD (or LWD) tools, collectively referred to by numeral 164, for estimating various properties of the formation 160. Such tools may include resistivity tools, acoustic tools, nuclear magnetic resonance (NMR) tools, gamma ray tools, nuclear logging tools, formation testing tools and other desired tools. Each such tool may process signals and data according to programmed instructions and provide information about certain properties of the formation. The downhole processor at the downhole control unit 170 may be used to calculate a parameter of interest from measurements obtained from the various LWD tools 164 using the methods described herein.

Still referring to FIG. 1, the drilling assembly 190 further includes a telemetry unit 172 that establishes two-way data communication between the devices in the drilling assembly 190 and a surface device, such as the control unit 140. Any suitable telemetry system may be used for the purpose of this disclosure, including, but not limited to: mud pulse telemetry, acoustic telemetry, electromagnetic telemetry and wired-pipe telemetry. In one aspect, the wired-pipe telemetry may include drill pipes made of jointed tubulars in which electrical conductors or fiber optic cables are run along individual drill pipe sections and wherein communication along pipe sections may be established by any suitable method, including, but not limited to: mechanical couplings, fiber optic couplings, electromagnetic signals, acoustic signals, radio frequency signals, or another wireless communication method. In another aspect, the wired-pipe telemetry may include coiled tubing in which electrical or fiber optic fibers are run along the length of coiled tubing. The drilling systems, apparatus and methods described herein are equally applicable to offshore drilling systems.

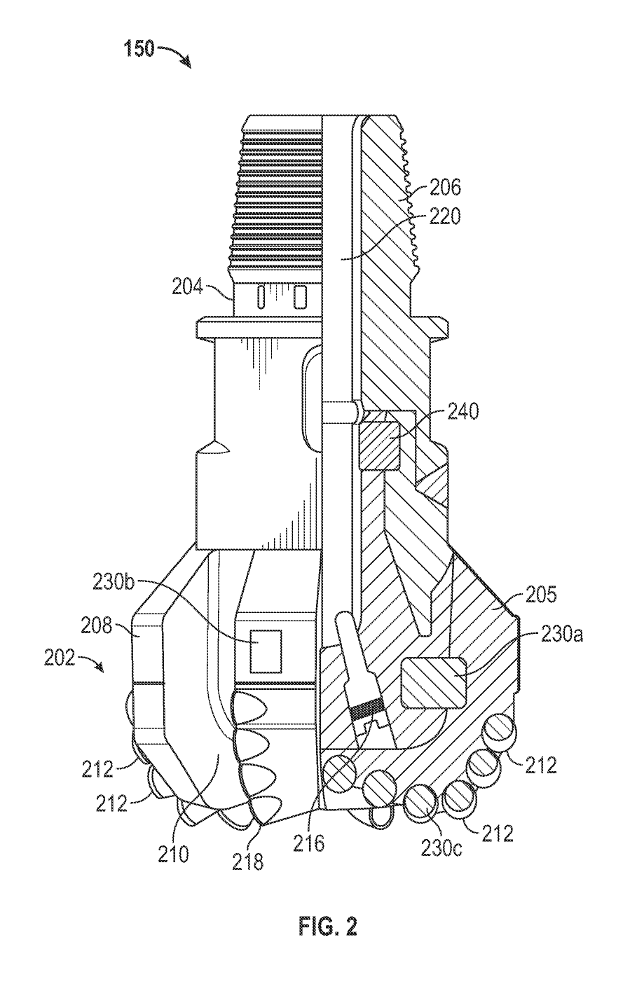

FIG. 2 shows an exemplary earth-boring drill bit 150 for generating an acoustic signal in an exemplary embodiment of the present disclosure. Although the drill bit shown in FIG. 2 is a polycrystalline diamond compact (PDC) drill bit, a roller cone drill bit may also be used in various embodiments of the present disclosure. The exemplary drill bit 150 includes a bit body 202 comprising a particle-matrix composite material 205 that includes a plurality of hard phase particles or regions dispersed throughout a low-melting point binder material. The hard phase particles or regions are “hard” in the sense that they are relatively harder than the surrounding binder material. In some embodiments, the bit body 202 may be predominantly comprised of the particle-matrix composite material 205. The bit body 202 may be fastened to a metal shank 204, which may be formed from steel and may include a threaded pin 206 for attaching the drill bit 150 to a drill string or bottomhole assembly, such as the exemplary bottomhole assembly 190 of FIG. 1.

As shown in FIG. 2, the bit body 202 may include blades 208 that are separated from one another by slots 210. The drill bit 150 may include a plurality of cutting elements 212 on the blades 208. A plurality of cutters 212 may be provided on each of the blades 208, as shown in FIG. 2. In various embodiments, the cutters may be polycrystalline diamond compact (PDC) cutters.

Longitudinal bore 220 extends through the steel shank 204 and at least partially through the bit body 202. Internal fluid passageways 216 may extend between the longitudinal bore 220 in the bit body 202 and a face 218 of the bit body 202. During drilling operations, the drill bit 150 may be positioned at the bottom of a well bore and rotated while drilling fluid is pumped through the longitudinal bore 220 into the internal fluid passageway 216 to the face 218 of the bit body 202. As the cutters 212 shear or engage the underlying earth formation, the formation cuttings and detritus are mixed with and suspended within the drilling fluid, which passes through the slots 210 and the annular space between the well borehole and the drill string to the surface of the earth formation.

The drill bit may further include one or more transducers such as exemplary transducers 230a-c that are operated as a controlled seismic source or a controlled acoustic source. In one embodiment, the transducer, such as transducer 230a, may be embedded in the composite material 205 of the bit body 202 in one embodiment. In alternate embodiments, the transducer, such as transducer 230b, may be located at a blade 208. In yet another embodiment, the transducer, such as transducer 230c, may be embedded or fabricated into a cutter of the drill bit. Various types of transducers may be used in various embodiments of the drill bit. In one embodiment, the transducer may be a piezo-electric transducer. Alternatively, the transducer may be a speaker that uses electromagnetic coils to vibrate acoustic membranes. In another embodiment, the transducer may include a piston which causes a hammering action in the bit or generates a hydraulic pulse in a fluid through the motion of a moving piston in a hydraulic chamber. In another embodiment, a laser source may be used to create an acoustic signal by heating either a fluid or formation. Additional embodiments may include a thermal actuator that generates an acoustic signal by a cavitation process in a surrounding media, and/or a magnetostrictive membrane that generates an acoustic signal when exposed to a changing magnetic field.

In various aspects of the present disclosure, an acoustic signal is generated at the drill bit 150. In one embodiment, the drill bit is operated to generate the acoustic signal. In another embodiment, the one or more transducers 230a-c in the drill bit may be activated to produce the acoustic signal. In yet another embodiment, the drill bit may be operated to produce a first acoustic signal and the one or more transducers may be activated concurrent with operation of the drill bit. The one or more transducers may produce a second acoustic signal, known as a filtering signal, that when combined with the first signal produces a filtered signal, as discussed below. The drill bit as well as the transducers can be controlled by an operator or using a processor.

The exemplary drill bit 150 may further include a seismic receiver 240, which is a sensor at the drill bit in various embodiments. The exemplary sensor 240 at the drill bit (“drill bit sensor”) is configured to receive the acoustic signal that is generated at the drill bit. The drill bit sensor 240 may be embedded in the drill bit, located at the drill bit or at a location proximate the drill bit. The generated acoustic signal received at the drill bit sensor may be affected generally by the matrix material 205 of the drill bit 150 but has not propagated through any other surrounding medium such as mud, drill string, formation, etc. Thus, the drill bit sensor 240 receives a signal that substantially represents the generated acoustic signal in its original waveform and frequency bandwidth. The drill bit sensor communicates the received signal to a downhole processor, such as the downhole processor of downhole control unit 170. The downhole processor receives the signals from the drill bit sensor 240 and determines a character of the generated acoustic signal. In various embodiments, determining the character of a signal, also referred to herein as characterizing a signal, may include determining a waveform of the signal, determining a frequency spectrum of the signal, etc. The downhole processor 120 may further perform other aspects of an acoustic test, including receiving a signal from a remote sensor related to propagation of the generated acoustic signal through a medium and comparing the remote signal to the characterized signal to determine a parameter of the medium. Alternatively, the downhole processor may communicate the characterized signal and various data to a surface processor for further processing.

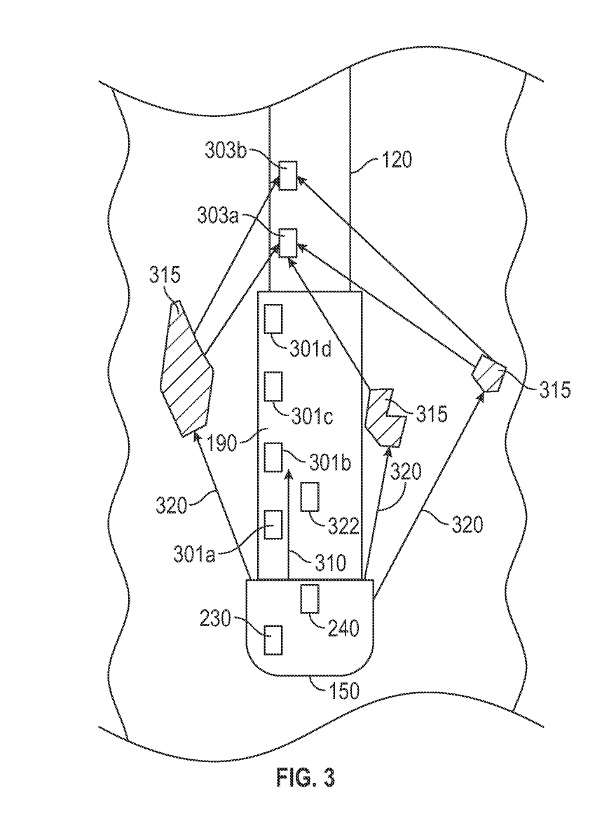

FIG. 3 shows the exemplary bit of FIG. 2 disposed at an exemplary bottomhole assembly (BHA) 190 at an end of an exemplary drill string 120 in one embodiment of the present disclosure. The exemplary BHA 190 includes one or more seismic receivers 302a-302d referred to herein as remote sensors, generally spaced at selected intervals along the BHA 190. The drill string also has one or more remote sensors such as exemplary remote sensors 303a and 303b. The number of remote sensors is not limited to those shown in FIG. 3. Any number of seismic receivers may be disposed on the BHA as well as on the drill string. The drill bit 150 is shown to include an acoustic transducer 230 and a drill bit sensor 240 for characterizing an acoustic signal generated at the drill bit. Also shown is a downhole processor 322, which may be the downhole processor discussed with respect to FIG. 1. The downhole processor 322 may be in data communication with the drill bit sensor 240 and the various exemplary seismic receivers 301a-301d and 303a and 303b and may perform various calculations discussed herein for estimating a parameter.

In one aspect, an acoustic signal generated at the drill bit 140 may be transmitted through the body of the BHA 190 to be received at remote sensors 301a-301b and/or 303a-303b. The signal propagated through the BHA/drill string is shown as propagated signal 310. Signals received at the one or more remote sensors 301a-301d in response to propagated signal 310 may therefore be used to determine a selected parameter of the BHA. In various embodiments, the selected parameter of the BHA is related to a health of the BHA. Thus, the health of the BHA may be determined from a comparison of the received propagated signal 310 with the characterized signal.

The exemplary BHA 190 and drillstring 120 are surrounded by the mud 131 in the annulus of the wellbore. In one embodiment, a generated acoustic signal propagates through the mud as shown by mud propagated signal 320 and is received at the one or more sensors. Gas influx 315 into the mud from the formation may alter a property of the mud that affects the propagated signal 320. Thus, the received mud propagated signal 320 may be compared to an expected propagation of the characterized acoustic signal to determine an influx of formation gas 315 into the mud.

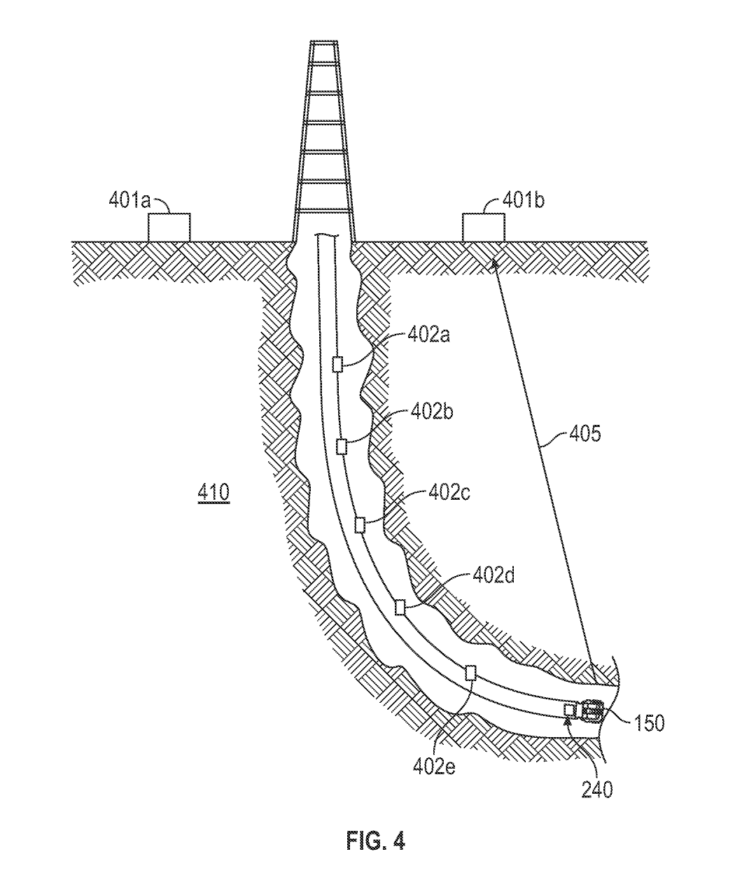

FIG. 4 shows the exemplary drill bit 150 at an end of a drill string that may be used, for example, to perform vertical profiling of a formation. Drill bit sensor 240 is located at or near the drill bit. The source signal is generated at the drill bit 150 and propagates into the surrounding formation 410. Exemplary receivers 401a and 401b may be located at a surface location to receive signals from the formation responsive to the propagated source signal 405. Alternately, receivers 402a-402e may be located along the drill string. Drill bit sensor 240 measures the generated acoustic signal and sends measurements related to the generated acoustic signal to a downhole processor for characterization. The received signals at receivers 402a-402e are compared to the characterized acoustic signal to determine a parameter of the formation 410.

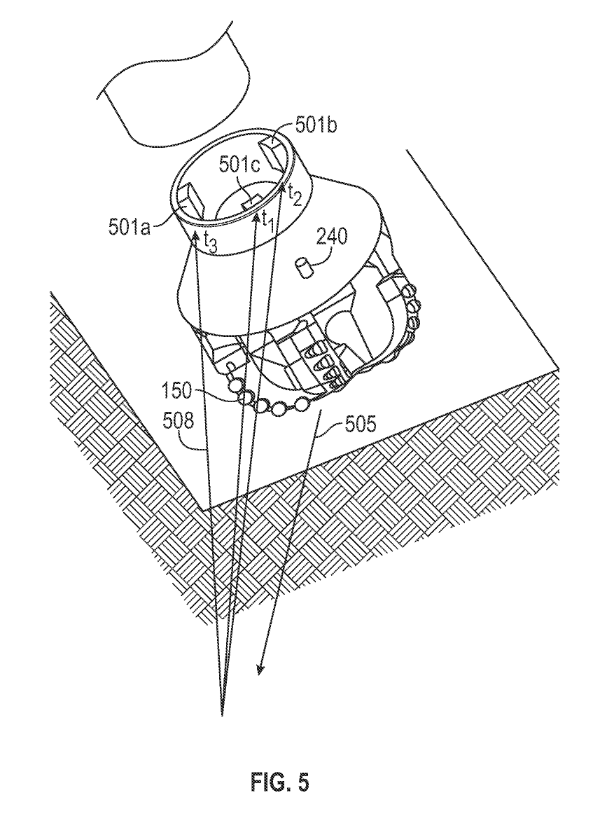

FIG. 5 shows a drill bit having a set of remote sensors 501a, 501b and 501c usable to measure a formation parameter in an alternate embodiment of the present disclosure. The remote sensors 501a, 501b and 501c may be located at the drill bit 150 or proximate the drill bit 150 at the BHA 190. In the exemplary embodiment, the receiving sensors are located 120 degrees apart along the circumference of the drill bit or BHA. Drill bit sensor 240 is used to characterize the generated acoustic signal according to the methods discussed herein. The drill bit 150 may be raised from the bottom of the wellbore and the drill bit and/or transducer may then be used to generate an acoustic signal. When the drill bit is raised from the formation, the generated acoustic signal has a relatively low noise level. Additionally, the drill bit can be varied to generate acoustic signals with varying frequency to allow sweeping of a frequency range. In one embodiment, the generated acoustic signal may be directed in a selected direction, for example, by use of a directional transducer or other methods. The propagated acoustic signal 505 may be reflected from a bottom of the wellbore or from a feature in the formation. A reflected signal or signals 508 from the formation may be received at the sensors 501a, 501b and 501c. The location of the feature may be determined based on time delays for the received reflected signal at the sensors 501a-501c. In addition, a parameter of the formation as well as a parameter and/or the location of the feature in the formation may be determined using the signals received at the sensors 501a, 501b and 501c and the characterized acoustic signal. Exemplary features may include bed boundaries, salt-carbonate boundaries, the presence of fluid, etc. In addition, a rock type may be identified using the characterized acoustic signal and various methods.

In another aspect, the transducer of the drill bit may be used to change a character of the generated acoustic signal to have a selected characteristic, waveform or spectral frequency. A first acoustic signal is generated at the drill bit generally by operation of the drill bit. The first signal is characterized at the drill bit to obtain a spectrum of the source signal. A processor may then activate the transducer or suitable damper to generate a second signal (a filtering signal) in a selected frequency range, wherein the filtering signal is used to filter the first signal over the selected frequency range to obtain a filtered signal. The filtered signal thus has a frequency spectrum that is different than the frequency spectrum of the first signal. This process may be used to filter noise or to create a signal having a selected character. As an example, a bit may generate an acoustic signal over an exemplary bandwidth from about 40 Hz to about 1.5 kHz. The spectrum is determined at the downhole processor. One or more transducers built into the bit may then be activated to generate a filtering acoustic signal over a selected range from about 500 Hz to about 1.5 kHz. The phase of the filtering signal may be selected to cancel or filter the acoustic signal from the drill bit over the selected range. The resulting filtered signal therefore has a bandwidth over a range from about 40 Hz to about 500 Hz.

In another aspect, the characterized signal may be used for acoustic telemetry. The sensor at the drill bit allows characterization of the acoustic signal generated by the drill bit. A model of a wave path through the formation to the surface may be used to either filter unsuitable components, or amplify those signals having a better chance of propagation. The signal characteristics can be encoded and transmitted with the telemetry link to allow higher fidelity in signal regeneration.

Therefore, in one aspect the present disclosure provides a method estimating a parameter of interest downhole, the method including: generating an acoustic signal at a drill bit downhole; receiving the generated acoustic signal at a sensor at the drill bit; determining a character of the generated acoustic signal from the received signal at the sensor at the drill bit; and estimating the downhole parameter of interest using the characterized signal. In one embodiment, the generated acoustic signal propagates through a medium, wherein the propagated signal is received at a remote sensor remote to the drill bit and compared to the characterized signal to determine the parameter of the medium. The remote sensor may be located at a bottomhole assembly, a drill string, a surface location and a drill bit, in various embodiments. The character of the generated acoustic signal may be determined at a downhole processor. Determining the character of the generated acoustic signal may include determining a waveform of the generated acoustic signal and/or determining a frequency spectrum of the generated acoustic signal. In another embodiment, a filtering signal may be determined that when combined with the generated acoustic signal produces a filtered acoustic signal having a selected character, and an acoustic device at the drill bit may be activated to generate the filtering signal. In various embodiments, determining the parameter of interest includes at least one of: (i) determining a parameter of mud; (ii) determining a presence of a gas in a mud; (iii) determining a parameter of a bottom hole assembly; (iv) determining a parameter of a drill string; and (v) determining a parameter of a formation; (vi) determining a location of a feature within a formation; and (vii) determining data communicated via acoustic telemetry signal. Generating the acoustic signal at the drill bit may include at least one of: (i) operating the drill bit to generate the acoustic signal; and (ii) activating an acoustic source located at one of: (a) in the bit, and (b) at a cutter of the bit. In another embodiment, the generated acoustic signal may be directed to a selected formation location and the signal propagated through the formation is received at one or more receivers at the drill bit, wherein a parameter of the formation at the selected location is determined from the received signals and the characterized acoustic signal.

In another aspect, the present disclosure provides an apparatus for estimating a parameter of interest downhole, including: an acoustic source at a drill bit located downhole configured to generated an acoustic signal; a sensor at the drill bit configured to receive the generated acoustic signal at the drill bit; and a processor configured to: determine a character of the generated acoustic signal from the signal received at the sensor at the drill bit, and estimate the downhole parameter of interest using the characterized signal. A remote sensor remote from the drill bit may receive a signal responsive to propagation of the source signal through a medium, wherein the processor compares the signal received at the remote sensor to the characterized signal to determine the parameter of the medium. In various embodiments, the remote sensor is located at at least one of: (i) a bottomhole assembly, (ii) a drill string; (iii) a surface location; and (iv) a drill bit. The processor may include a downhole processor. The processor may further determine the character of the generated acoustic signal by performing at least one of: (i) determining a waveform of the generated acoustic signal; and (ii) determining a frequency spectrum of the generated acoustic signal. The processor may be further configured to determine a filtering signal that when combined with the generated acoustic signal produces a filtered acoustic signal having a selected character, and activate an acoustic device at the drill bit to generate the filtering signal. The processor may determine the parameter of interest by performing at least one of: (i) determining a parameter of mud; (ii) determining a presence of a gas in a mud; (iii) determining a parameter of a bottom hole assembly; (iv) determining a parameter of a drill string; and (v) determining a parameter of a formation; (vi) determining a location of a feature within a formation; and (vii) determining data communicated via acoustic telemetry signal. In various embodiments, the acoustic source further comprises at least one selected from the group consisting of: (i) the drill bit; and (ii) an acoustic source located at one of: (a) in the bit, and (b) at a cutter of the bit. The acoustic source may further direct the generated acoustic signal to a selected formation location, wherein the processor determines a parameter of the formation at the selected location using a propagated signal in the formation responsive to the directed acoustic signal.

In yet another aspect, the present disclosure provides a downhole acoustic testing system that includes a drillstring disposed in a wellbore; an acoustic source located at a downhole end of the drill string configured to generated an acoustic signal; a sensor located proximate the source configured to receive the generated acoustic signal; and a processor configured to: determine a character of the generated acoustic signal from the signal received at the sensor at the drill bit, and estimate a downhole parameter of interest using the characterized signal. A remote sensor remote from the acoustic source may receive a signal responsive to propagation of the generated acoustic signal through a medium, wherein the processor is further configured to compare the signal received at the remote sensor to the characterized signal to determine the parameter of the medium.

While the foregoing disclosure is directed to the certain exemplary embodiments of the disclosure, various modifications will be apparent to those skilled in the art. It is intended that all variations within the scope and spirit of the appended claims be embraced by the foregoing disclosure.

1. A method estimating a parameter of interest downhole, comprising:
generating an acoustic signal at a drill bit downhole;
receiving the generated acoustic signal at a sensor at the drill bit;
determining a character of the generated acoustic signal from the received signal at the sensor at the drill bit; and
estimating the downhole parameter using the characterized acoustic signal.

2. The method of claim 1, wherein the generated acoustic signal propagates through a medium, further comprising receiving the propagated signal at a remote sensor remote to the drill bit, and comparing the signal received at the remote sensor to the characterized acoustic signal to determine the parameter of the medium.

3. The method of claim 2, wherein the remote sensor is located at at least one of: (i) a bottomhole assembly; (ii) a drill string; (iii) a surface location; and (iv) a drill bit.

4. The method of claim 1, further comprising determining the character of the generated acoustic signal at a downhole processor.

5. The method of claim 1, wherein determining the character of the generated acoustic signal further comprises performing at least one action selected from the group consisting of: (i) determining a waveform of the generated acoustic signal; and (ii) determining a frequency spectrum of the generated acoustic signal.

6. The method of claim 1 further comprising determining a filtering signal that when combined with the generated acoustic signal produces a filtered acoustic signal having a selected character, and activating an acoustic device at the drill bit to generate the filtering signal.

7. The method of claim 1, wherein determining the parameter of interest further comprises at least one of: (i) determining a parameter of mud; (ii) determining a presence of a gas in a mud; (iii) determining a parameter of a bottom hole assembly; (iv) determining a parameter of a drill string; and (v) determining a parameter of a formation; (vi) determining a location of a feature within a formation; and (vii) determining data communicated via acoustic telemetry signal.

8. The method of claim 1, wherein generating the acoustic signal at the drill bit further comprises at least one of: (i) operating the drill bit to generate the acoustic signal; and (ii) activating an acoustic source located at one of: (a) in the bit, and (b) at a cutter of the bit.

9. The method of claim 1 further comprising directing the generated acoustic signal to a selected formation location, receiving a signal propagated through the formation at one or more receivers, and determining a parameter of the formation at the selected location from the received signals and the characterized acoustic signal.

10. An apparatus for estimating a parameter of interest downhole, comprising:
an acoustic source at a drill bit located downhole configured to generated an acoustic signal;
a sensor at the drill bit configured to receive the generated acoustic signal at the drill bit; and
a processor configured to:
determine a character of the generated acoustic signal from the signal received at the sensor at the drill bit, and
estimate the downhole parameter of interest using the characterized signal.

11. The apparatus of claim 10 further comprising a remote sensor remote from the drill bit configured to receive a signal responsive to propagation of the generated acoustic signal through a medium, wherein the processor is further configured to compare the signal received at the remote sensor to the characterized signal to determine the parameter of the medium.

12. The apparatus of claim 11, wherein the remote sensor is located at at least one of: (i) a bottomhole assembly, (ii) a drill string; (iii) a surface location; and (iv) a drill bit.

13. The apparatus of claim 10, wherein the processor further comprises a downhole processor.

14. The apparatus of claim 10, wherein the processor is further configured to determine the character of the generated acoustic signal by performing at least one action selected from the group consisting of: (i) determining a waveform of the generated acoustic signal; and (ii) determining a frequency spectrum of the generated acoustic signal.

15. The apparatus of claim 10, wherein the processor is further configured to:
determine a filtering signal that when combined with the generated acoustic signal produces a filtered acoustic signal having a selected character, and
activate an acoustic device at the drill bit to generate the filtering signal.

16. The apparatus of claim 10, wherein the processor is further configured to determine the parameter of interest by performing at least one of: (i) determining a parameter of mud; (ii) determining a presence of a gas in a mud; (iii) determining a parameter of a bottom hole assembly; (iv) determining a parameter of a drill string; and (v) determining a parameter of a formation; (vi) determining a location of a feature within a formation; and (vii) determining data communicated via acoustic telemetry signal.

17. The apparatus of claim 10, wherein the acoustic source further comprises at least one selected from the group consisting of: (i) the drill bit; and (ii) an acoustic source located at one of: (a) in the bit, and (b) at a cutter of the bit.

18. The apparatus of claim 10, wherein the acoustic source is further configured to direct the generated acoustic signal to a selected formation location, and the processor is further configured to determine a parameter of the formation at the selected location using a propagated signal in the formation responsive to the directed acoustic signal.

19. A downhole acoustic testing system, comprising:
a drillstring disposed in a wellbore;
an acoustic source located at a downhole end of the drill string configured to generated an acoustic signal;
a sensor located proximate the source configured to receive the generated acoustic signal; and
a processor configured to:
determine a character of the generated acoustic signal from the signal received at the sensor at the drill bit, and
estimate a downhole parameter of interest using the characterized signal.

20. The system of claim 19 further comprising a remote sensor remote from the acoustic source configured to receive a signal responsive to propagation of the generated acoustic signal through a medium, wherein the processor is further configured to compare the signal received at the remote sensor to the characterized signal to determine the parameter of the medium.
